(19) United States
(12) Patent Application Publication
(10) Pub. No.: US 2013/0242244 A1
(43) Pub. Date: Sep. 19, 2013

(54) METHODS AND APPARATUS FOR ELECTRICALLY CONNECTING A SUBSTRATE AND ELECTRICALLY CONDUCTIVE GLASS

(71) Applicants: Frank Supon, Louisville, CO (US); Shin-Ying Lu, Longmont, CO (US)

(72) Inventors: Frank Supon, Louisville, CO (US); Shin-Ying Lu, Longmont, CO (US)

(21) Appl. No.: 13/423,493

(22) Filed: Mar. 19, 2012

(51) Int. Cl. G02F 1/1333; B05D 5/12; B32B 37/14; G02F 1/1343; B32B 37/12

(52) U.S. Cl. 349/122; 349/139; 156/60; 427/122

(57) ABSTRACT

A liquid crystal panel and method are disclosed in which a substrate is electrically connected to an electrically conductive glass using a carbon black conductor formed from an electrically conductive carbon black adhesive.

### FIELD OF THE INVENTION

Embodiments of the present invention are generally related to the field of liquid crystal displays, and, more particularly, to the optical performance of such displays.

### BACKGROUND

A liquid crystal (LC) display cell can have an electrically conductive glass layer over a liquid crystal layer which can be supported by a silicon backplane substrate. The LC display cell can be die-attached to a printed circuit board to produce an LC panel. The printed circuit board can be used to make electrical connections to the cell for power and data purposes. A conventional LC panel can have one or more electrical connections directly between the electrically conductive glass and the printed circuit board. Power can be supplied from the printed circuit board to the conductive glass through a conductive adhesive pillar without passing through the silicon substrate. These electrical connections can be made from a conductive adhesive which can be formed into one or more pillars to connect a conductive layer of the conductive glass to a conductive trace on the circuit board.

A diagrammatic elevational view of a conventional LC panel is shown in FIG. 1 and is generally designated using reference number 10. Panel 10 can have a display cell 12 die-attached to a printed circuit board 14, such as FR4. Display cell 12 can include an electrically conductive glass layer 16, a liquid crystal layer 18 and a silicon backplane substrate 20. Other layers can be included, but are not shown in this simplified example for purposes of clarity. The electrically conductive glass can have an overhang such that the glass overhangs the LC and silicon substrate layers. A pillar 24 of conductive adhesive can be formed between the printed circuit board and overhang of the conductive glass to electrically connect the printed circuit board to the conductive glass. In this arrangement, the pillar does not contact the LC or silicon backplane substrate layers, but instead extends directly from the printed circuit board to the conductive glass.

During operation, the display cell applies electrical field signals across the liquid crystal layer between pixel electrodes of the silicon backplane substrate and the electrically conductive glass to change a characteristic of the liquid crystal to modulate light for creating an image. If the electrical connection through the pillar is broken, then the display cell is unable to create the electrical fields and the display cell becomes non-functional.

The pillar can be formed after display cell 12 is die-attached to the printed circuit board using carefully controlled dispense methods and custom made dispensing equipment.

It is recognized that the pillar can be a source of failure in the LC panel. Since the pillar is required to span at least the thickness of the silicon substrate and the LC layer, the pillar can be on the order of 0.7 mm thick. The thickness of the pillar can exceed the recommended maximum thickness of the conductive adhesive used to form the posts. As a result of the required thickness, the pillar can be subject to handling related mechanical failure. The pillar can also be subject to failure caused by adverse environmental conditions, such as high temperature and high humidity.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic side view of certain layers of a conventional liquid crystal panel.

FIG. 2 is a diagrammatic side view of an embodiment of a liquid crystal panel with a silicon substrate and having an electrical connection according to the present disclosure.

FIG. 3 is a diagrammatic top view of an embodiment of a liquid crystal panel having an electrical connection according to the present disclosure.

FIG. 4 is a diagrammatic top view of another embodiment of a liquid crystal panel having an electrical connection according to the present disclosure.

FIG. 5 is a diagrammatic top view of yet another embodiment of a liquid crystal panel having an electrical connection according to the present disclosure.

FIG. 6 is a diagrammatic side view of an embodiment of a liquid crystal panel with a glass substrate having an electrical connection according to the present disclosure.

FIG. 7 is a diagrammatic top view of an embodiment of the liquid crystal panel of FIG. 6.

FIG. 8 is a flow diagram illustrating an embodiment of a method involving the application of electrical connection according to the present disclosure.

FIG. 9 is a flow diagram illustrating another embodiment of a method involving the application of an electrical connection according to the present disclosure.

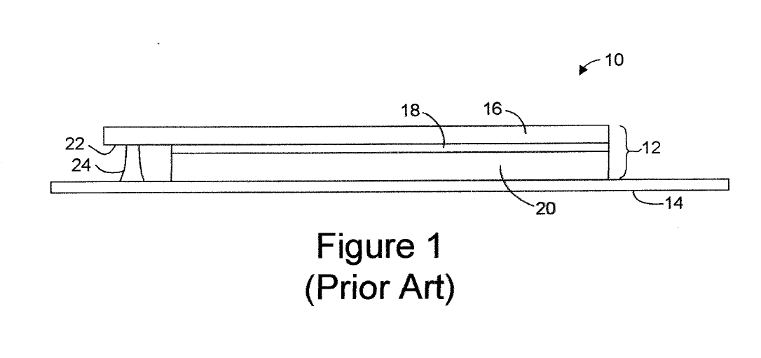

### DETAILED DESCRIPTION

The following description is presented to enable one of ordinary skill in the art to make and use embodiments of the invention and is provided in the context of a patent application and its requirements. Various modifications to the described embodiments will be readily apparent to those skilled in the art and the generic principles taught herein may be applied to other embodiments. Thus, embodiments of the present invention are not intended to be limited to the embodiments shown, but are to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

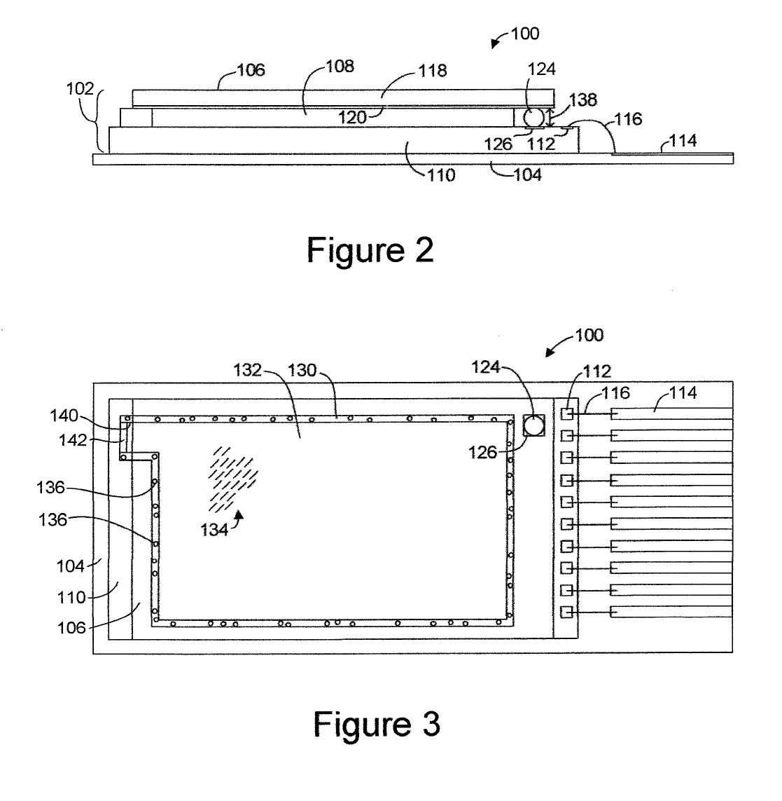

Attention is now directed to the remaining figures wherein like reference numbers may refer to like components throughout the various views. FIG. 2 is a diagrammatic representation of an embodiment of a liquid crystal on silicon (LCOS) panel in a side view, generally indicated by reference number 100. LCOS panel 100 includes a display cell 102 which is die-attached to a printed circuit board 104. Display cell 102 can be a laminate which includes an electrically conductive glass 106, a liquid crystal (LC) layer 108 and a silicon backplane substrate 110. The display cell can include bond pads 112 which can be used to electrically connect the display cell to electrical traces 114 of the printed circuit board using wire bonds 116. Electrically conductive glass 106 can include a glass layer 118 and a transparent electrically conductive layer 120, such as Indium-Tin-Oxide (ITO) on the side facing the LC layer. Other suitable embodiments of electrically conductive glass can be used, as is known to a person of ordinary skill in the art. The display cell can include layers other than those shown in FIG. 2, such as for example alignment layers. In addition, each of the layers discussed can be made up of one or more different areas and sub-layers that form an entire layer but which are not individually shown for purposes of clarity.

Turning now to FIG. 3 in conjunction with FIG. 2, LCOS panel 100 includes a carbon black conductor 124 made from a carbon black doped adhesive. Carbon black conductor 124 is electrically conductive and can span relatively small gaps as discussed below. The carbon black conductor is positioned between silicon substrate 110 and electrically conductive glass 106 to electrically connect a contact area 126 of the silicon substrate to transparent electrically conductive layer 120 of the electrically conductive glass. Contact area 126 can be formed on the silicon substrate and can be electrically connected one or more bond pads 112, wire bond 116 and electrical trace 114 to receive a signal source for powering the electrically conductive glass. The contact area, for example, can be formed of metal using conventional semiconductor manufacturing processes, and can be connected to the signal source using the silicon substrate, the wire bonds and/or the circuit board traces or other electrical connections formed using conventional manufacturing techniques. The contact area can be large or small as long as sufficient electrical conductivity is provided to sufficiently pass the signals to the carbon black conductor.

Referring now to FIG. 3 which is a diagrammatic top view, LC layer 108 includes an LC reservoir 132 containing a liquid crystal material 134. The LC layer can have a liquid crystal perimeter seal 130 which contains the liquid crystal material in the LC reservoir. During the assembly of the display cell, the liquid crystal perimeter seal can be formed on either the electrically conductive glass or the silicon substrate. The liquid crystal perimeter seal can be made from an adhesive and can be applied using a syringe needle or can be printed using offset printing, an ink jet printer, or other suitable printing or application methods. The perimeter seal can bond the electrically conductive glass to the silicon substrate to create laminated display cell 102. The perimeter seal, electrically conductive glass and silicon substrate form the boundaries of LC reservoir 132.

The liquid crystal layer can have spacers 136 which can be located in the perimeter seal and/or in the reservoir to maintain a gap 138 (FIG. 2) between the electrically conductive glass and the silicon substrate. The spacers can be particles of silica or polymer or another material having a specific dimension that is substantially the same as gap 138. During manufacture, the perimeter seal can be formed with an opening 140 so that the reservoir can be filled with liquid crystal material 134 after the perimeter seal has cured. After the reservoir is filled through the opening, the reservoir can be sealed with a plug 142 which can be formed using an adhesive such as the adhesive used for the perimeter seal.

In the embodiment shown in FIGS. 2 and 3, carbon black conductor 124 can be positioned external to perimeter seal 130 of the LC layer to bridge gap 138 to electrically connect the conductive layer 120 of the electrically conductive glass to contact area 126. The carbon black conductor can be applied to contact area 126 before or after the formation of the perimeter seal and the carbon black conductor can electrically connect to the electrically conductive glass when the display cell is assembled into the laminate. In an embodiment, when the display cell is assembled, gap 138 and carbon black conductor 124 can be one micron or less since spacers 136 can be one micron or less. One or more spacers can also be included in the carbon black conductor to maintain the distance between the electrically conductive glass and the substrate. In another embodiment, the carbon black conductor can have a thickness of less than approximately 3.5 microns and can still produce acceptable results for conducting electrical signals.

Carbon black conductor 124 can be made, by way of non-limiting example, using a mixture of carbon black and adhesive. The carbon black can be a high purity carbon black that is 99.9% carbon black particles having an average particle size of approximately 0.042 micron, such as is produced by Alpha Aesar Company, Ward Hill, Mass., Stock number 39724. The carbon black can be mixed with a UV curing acrylic adhesive, epoxy adhesive or other optical adhesive. The carbon black adhesive can be produced by mixing the carbon black by weight with the adhesive. A range of about 2% to about 10% by weight of carbon black to adhesive can be used, with about 5% by weight having good conductivity and workability. When too much carbon black is used in the mixture, the viscosity becomes excessive and the mixture is difficult to work with. When too little carbon black is used in the mixture, the mixture does not exhibit a high enough conductivity. A workable mixture can have a gel like consistency which can be formed to hold a shape to allow time for curing. In one embodiment, an overall resistance of under approximately 500 Ohms for the combination of the electrically conductive glass and the carbon black connector can be sufficient for operation of LCOS panel 100.

The carbon black conductor can be applied to the substrate using an application process that is used for forming the perimeter seal. Because of this, the application of the carbon black conductor does not require special dispensing methods or custom made dispensing equipment. The formation of the carbon black conductor can be accomplished using typical manufacturing processes and the thickness of the carbon black conductor can fall within the thickness ranges specified by adhesive manufacturers. Since carbon black conductor 124 only has to extend across gap 138 between the electrically conductive glass and the silicon substrate, which is relatively small in comparison to the pillar discussed above, mechanical stresses on the carbon black conductor can be reduced relative to a conventional pillar. While the pillar type structure can be made from a conventional conductive adhesive, these conventional conductive adhesives can have particles that are too large to be used between the electrically conductive layer and the substrate. Other conventional conductive adhesives can include silver or gold nano-particles which can be mixed with adhesives in percentages by weight that are greater than 40% to achieve usable conductivity. In addition to the high cost of using precious metal particles in these adhesives, such high concentrations of particles can result in high viscosities which can create difficulties when working with these conventional conductive adhesives.

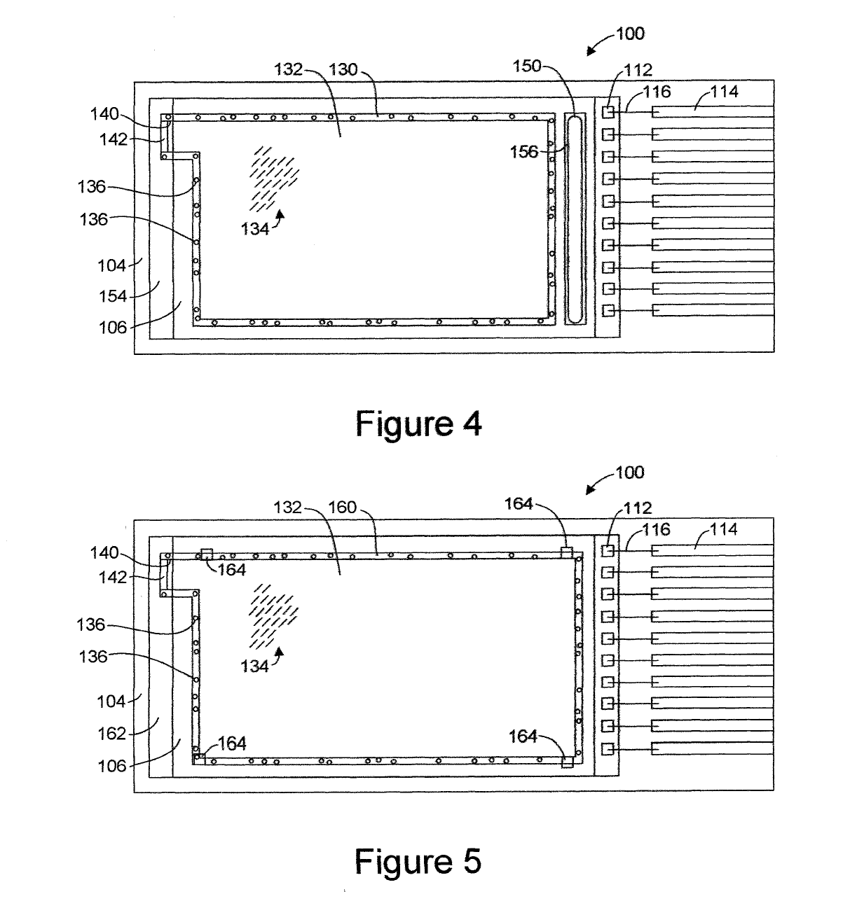

In an embodiment shown in FIG. 4, a carbon black conductor 150 can be formed in the shape of a line and can be positioned external to perimeter seal 130. Line-shaped carbon black conductor 150 can be electrically connected to a substrate 154 which can have one or more contact areas 156. Carbon black conductor 150 can electrically connect between an electrically conductive layer of electrically conductive glass 158 and the contact areas of substrate 154. Line-shaped carbon black conductor 150 can have a relatively lower resistance than the substantially dot shaped carbon black conductor 124 shown in FIGS. 2 and 3 since carbon black conductor 150 can dispose more conductive material between the electrically conductive glass and the substrate and more material in contact with both the electrically conductive glass and the substrate.

In an embodiment shown in FIG. 5, the carbon black adhesive can be used to form a carbon black conductor perimeter seal 160. A silicon substrate 162 can have one or more contact areas 164 positioned to electrically connect to electrically conductive glass 106 through perimeter seal 160. By using the carbon black conductor perimeter seal, more conductive material can be placed between the electrically conductive glass and the substrate to provide a relatively lower overall resistance. In addition, by using the perimeter seal conductor, an area on the substrate does not have to be used for externally placing the carbon black conductor. Using the carbon black material for the perimeter seal conductor can be integrated into the manufacture of the LCOS panel without having to introduce additional printing steps. Spacers 136 can be mixed into the carbon black material and can serve to maintain the gap between the electrically conductive glass and the substrate.

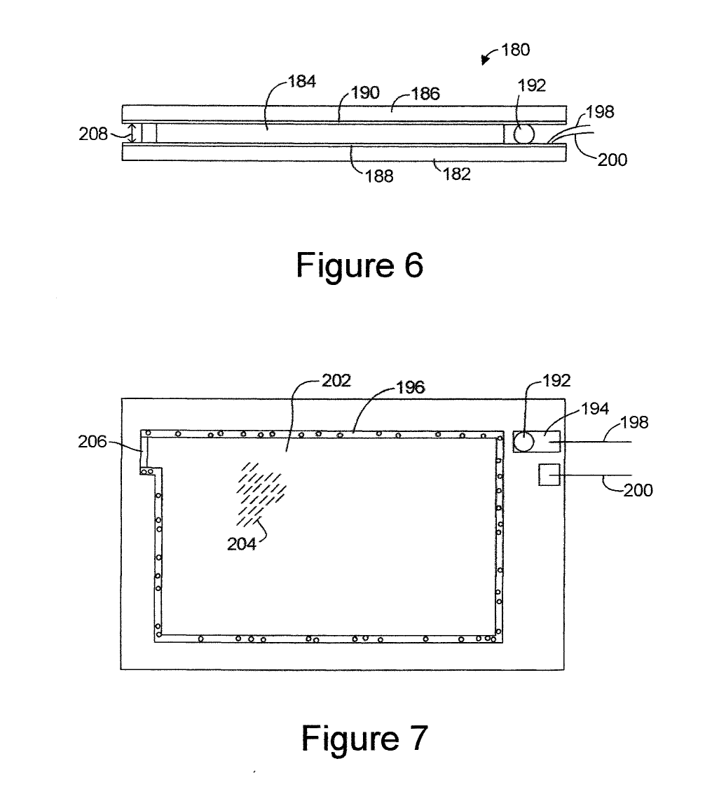

Turning now to FIG. 6, a diagrammatic side view of an LC panel 180 is shown. LC panel 180 includes a glass substrate 182, an LC layer 184 and an electrically conductive glass 186. Glass substrate 182 can have an electrically conductive layer 188 and electrically conductive glass 186 can have an electrically conductive layer 190. LC panel 180 can selectively modulate light passing through the device using the LC layer under the control of the electrically conductive layers 188 and 190. LC panel can be utilized in a flat panel display or can be a polarization rotator or other type of LC panel which uses an LC layer to modulate light passing through the panel.

Referring now to FIG. 7 in conjunction with FIG. 6, a carbon black conductor 192 can electrically connect electrically conductive layer 190 to a contact area 194 of glass substrate 182. Contact area 194 can be electrically isolated from the remainder of conductive layer 188. The carbon black conductor 192 can be applied to the contact area so that contact area 194 of conductive layer 188 is electrically connected to the electrically conductive layer 190 of the electrically conductive glass when substrate 182, LC layer 184 and electrically conductive glass 186 are laminated together with a perimeter seal 196. An electrical signal wire 198 can be soldered to contact area 194 and an electrical signal wire 200 can be soldered to conductive layer 188 electrically isolated from the signal wire 198. Perimeter seal 196 can provide a perimeter of an LC reservoir 202 which can be filled with a liquid crystal material 204 and a plug 206 can contain the LC material in the reservoir.

The LC layer of LC panel 180 can be approximately 1 micron or less in thickness depending on the dimensions of spacers used to maintain a gap 208 between glass substrate 182 and electrically conductive layer 190. The carbon black conductor can be positioned externally to the perimeter seal or can be used for the perimeter seal. While LC panel 180 only shows a single electrical connection for each of glass substrate 182 and electrically conductive glass 186, multiple electrical connections can be made to either the substrate or the electrically conductive glass. For example, electrically conductive layer 188 of the glass substrate can include an array of pixels, each of which can have a separate electrical connection. The carbon black conductor allows all of the wires to be soldered onto the glass substrate which can make manufacturing in volume more efficient, especially in the case where electrically conductive layer 188 has been patterned into multiple pixels.

LC panels having an electrically conductive glass, such as represented by FIGS. 2 and 6, typically include a polyimide (PI) alignment layer between the LC material and the electrically conductive layer of the electrically conductive glass. This PI layer does not interfere with the electrical connection between the carbon black conductor and the electrically conductive layer of the glass even if the PI layer is not removed.

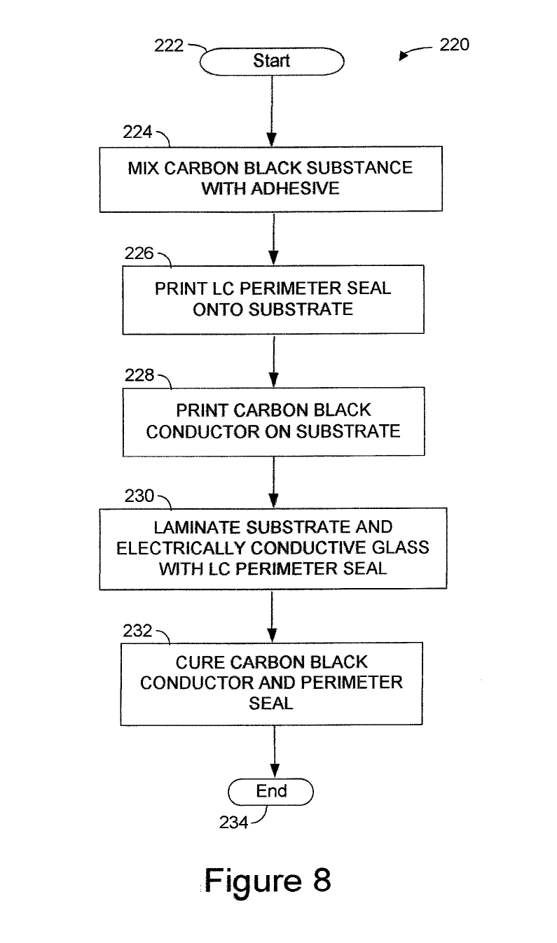

Turning now to FIG. 8, a flow diagram illustrating an embodiment of a method involving the application of the carbon black conductor is generally indicated by reference number 220. Method 220 begins at a start 222 and proceeds to 224 where a carbon black substance or other suitable electrically conductive material is mixed with an adhesive to produce a carbon black adhesive. Spacers can also be mixed with the carbon black adhesive. Method 220 then proceeds to 226 where an LC perimeter seal is printed onto a substrate. Method 220 then proceeds to 228 where a carbon black conductor of carbon black adhesive is printed onto the substrate at a position to electrically connect the carbon black conductor to the substrate. Method 220 then proceeds to 230 where the substrate and an electrically conductive glass are laminated together with the LC perimeter seal. Method 220 then proceeds to 232 where the LC perimeter seal and the carbon black conductor are hardened by curing. Method 220 then proceeds to 234 where the method ends.

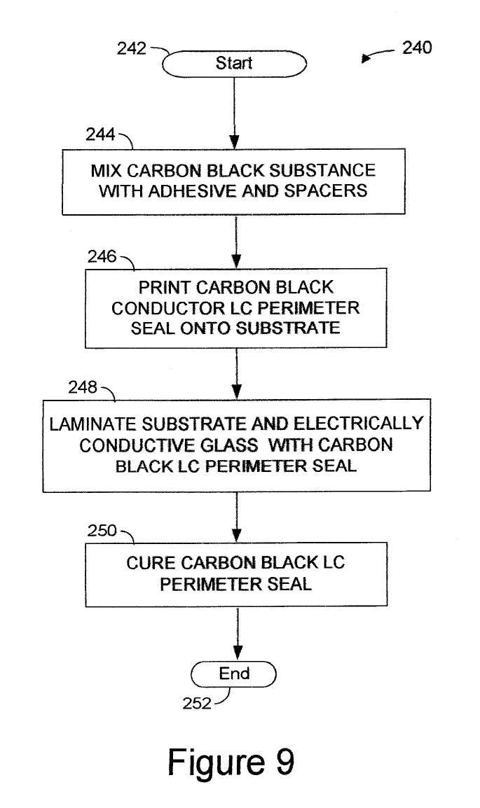

Turning now to FIG. 9, a flow diagram illustrating another embodiment of a method involving the application of the carbon black conductor is generally indicated by reference number 240. Method 240 begins at start 242 and proceeds to 244 where a carbon black substance or other suitable electrically conductive material is mixed with an adhesive and spacers to produce a carbon black adhesive. Method 240 then proceeds to 246 where a carbon black conductor LC perimeter seal is printed with the carbon black adhesive onto a substrate at a position to electrically connect the carbon black conductor to the substrate. Method 240 then proceeds to 248 where the substrate and an electrically conductive glass are laminated together with the carbon black conductor LC perimeter seal. Method 240 then proceeds to 250 where the perimeter seal is cured. Method 240 then proceeds to 252 where the method ends.

The foregoing descriptions of the invention have been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A liquid crystal display panel comprising:
a substrate;
a transparent electrically conductive glass supported by the substrate;
a liquid crystal material captured between the substrate and the transparent electrically conductive glass; and
a carbon black doped adhesive applied to electrically connect the transparent electrically conductive glass directly to the substrate of the display panel.

2. The liquid crystal display panel of claim 1 wherein the substrate is a silicon backplane substrate.

3. The liquid crystal display panel of claim 2 wherein the silicon backplane substrate includes a metal contact area for conducting electricity between the silicon substrate and the carbon black doped adhesive.

4. The liquid crystal display panel of claim 1 wherein the substrate is a transparent electrically conductive glass substrate.

5. The liquid crystal display panel of claim 1 further comprising spacers in the carbon black doped adhesive that are sized to maintain a gap between the substrate and the transparent electrically conductive glass.

6. The liquid crystal display panel of claim 1 further comprising:
a liquid crystal layer perimeter seal formed from the carbon black doped adhesive and arranged to retain the liquid crystal material between the transparent electrically conductive glass and the substrate and to electrically connect the transparent electrically conductive glass to the substrate.

7. The liquid crystal display panel of claim 1 wherein the carbon black doped adhesive has a thickness of less than one micron between the transparent electrically conductive glass and the substrate.

8. The liquid crystal display panel of claim 1 wherein the carbon black doped adhesive has a thickness of less than approximately 3.5 microns.

9. The liquid crystal display panel of claim 1 wherein the transparent electrically conductive glass is an assembly of indium-tin-oxide (ITO) and glass.

10. The liquid crystal display panel of claim 1 wherein the carbon black doped adhesive includes carbon black in a range of 2% to 10% by weight.

11. The liquid crystal display panel of claim 1 wherein the carbon black doped adhesive includes approximately 5% by weight of carbon black.

12. The liquid crystal display panel of claim 11 wherein the carbon black doped adhesive includes an ultraviolet curing acrylic adhesive.

13. The liquid crystal display panel of claim 11 wherein the carbon black doped adhesive includes an epoxy adhesive.

14. The liquid crystal display panel of claim 1 wherein the carbon black doped adhesive is formed as a dot.

15. The liquid crystal display panel of claim 1 wherein the carbon black doped adhesive is formed as a line.

16. A liquid crystal display panel comprising:
a substrate;
a transparent electrically conductive glass supported by the substrate;
a liquid crystal material captured between the substrate and the transparent electrically conductive glass; and
a conductor arranged between the substrate and the transparent electrically conductive glass for electrically connecting the transparent electrically conductive glass to the substrate.

17. A method comprising:
applying a carbon black doped adhesive to directly electrically connect a transparent electrically conductive glass of a display to a substrate of the display.

18. The method of claim 17 further comprising:
forming the carbon black doped adhesive as a perimeter seal of the microdisplay.

19. The method of claim 17 further comprising:
applying the carbon black doped adhesive in a thickness of less than one micron between the transparent electrically conductive glass and the substrate.

20. The method of claim 17 further comprising:
mixing carbon black in a range of 2% to 10% by weight with an adhesive to produce the carbon black doped adhesive.

21. The method of claim 20 further comprising:
mixing spacers with the carbon black and adhesive.

22. The method of claim 17 further comprising:
mixing approximately 5% carbon black by weight with an ultraviolet curing acrylic adhesive to produce the carbon black doped adhesive.

23. The method of claim 17 further comprising:
applying the carbon black doped adhesive in a thickness of less than approximately 3.5 microns.

24. The method of claim 17 further comprising:
mixing the carbon black doped adhesive in a ratio of carbon black to adhesive based at least partially on a conductivity of the resulting carbon black doped adhesive.

25. The method of claim 24 further comprising:
mixing the carbon black doped adhesive in a ratio of carbon black to adhesive based on the conductivity of the resulting carbon black doped adhesive and the transparent electrically conductive glass.

26. The method of claim 17 further comprising:
mixing the carbon black doped adhesive in a ratio of carbon black to adhesive based at least partially on a viscosity of the resulting carbon black doped adhesive.

27. A method comprising:
printing a perimeter seal of a liquid crystal panel with a carbon black doped adhesive to provide an electrically conductive path between an electrically conductive transparent glass and a substrate.
